(19) United States
(12) Patent Application Publication
(10) Pub. No.: US 2016/0026858 A1
(43) Pub. Date: Jan. 28, 2016

(54) IMAGE BASED SEARCH TO IDENTIFY OBJECTS IN DOCUMENTS

(71) Applicant: Microsoft Corporation, Redmond, WA (US)

(72) Inventor: Matthew Vogel, Seattle, WA (US)

(21) Appl. No.: 14/445,040

(22) Filed: Jul. 28, 2014

(51) Int. Cl. G06K 9/00; G06K 9/52; G06F 17/30; G06K 9/62; G06K 9/46; G06K 9/18

(52) U.S. Cl. CPC G06K 9/00456; G06K 9/46; G06K 9/18; G06F 17/30259; G06K 9/6201; G06F 17/3028; G06K 9/52; G06K 2009/4666

(57) ABSTRACT

An image based search is provided to identify objects in documents. An image may be processed to identify an object within a portion of the image. The image is embedded within a document. Portion of the image is converted into the object. The object includes a chart, a table, among others. Searchable content associated with the object is detected. The object and the searchable content is provided for export.

### BACKGROUND

People interact with computer applications through user interfaces. While audio, tactile, and similar forms of user interfaces are available, visual user interfaces through a display device are the most common form of a user interface. With the development of faster and smaller electronics for computing devices, smaller size devices such as handheld computers, smart phones, tablet devices, and comparable devices have become common Such devices execute a wide variety of applications ranging from communication applications to complicated analysis tools. Many such applications render content through a display and enable users to provide input associated with the applications' operations.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing an image based search to identify objects in documents. In some example embodiments, an application, such as an imaging application or a document application, may process an image to identify an object within a portion of the image. The image may be retrieved from a document such as a text based document, a spreadsheet document, a presentation document, among others. The object may include a table, a chart, among others. The portion of the image may be converted into the object. Searchable content associated with the object may be detected. The object and the searchable content may be provided for export. The object and the searchable content may be exported to other applications to allow the other applications to search for the object using the searchable content.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating components of a scheme to provide an image based search to identify objects in documents, according to embodiments;

FIG. 2 illustrates an example of processing an image within a document to identify a table as an object and searchable content of the object, according to embodiments;

FIG. 3 illustrates an example of processing an image within a document to identify a chart as an object and searchable content of the object, according to embodiments;

FIG. 4 illustrates an example of processing an image from a video recording to identify an object within the image and searchable content of the object, according to embodiments;

FIG. 5 is a simplified networked environment, where a system according to embodiments may be implemented;

FIG. 6 illustrates a general purpose computing device, which may be configured to provide an image based search to identify objects in documents; and

FIG. 7 illustrates a logic flow diagram for a process to provide an image based search to identify objects in documents, according to embodiments.

### DETAILED DESCRIPTION

As briefly described above, an image based search may be provided to identify objects in documents by an application. The application may process an image to identify an object within a portion of the image. The portion of the image may be converted into the object. Searchable content associated with the object may be detected. The object and the searchable content may be provided for export. The object and the searchable content may be exported to other applications to allow the other applications to search for the object using the searchable content.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, and a flash drive.

Throughout this specification, the term “platform” may be a combination of software and hardware components to provide an image based search to identify objects in documents. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example embodiments may be found in the following description.

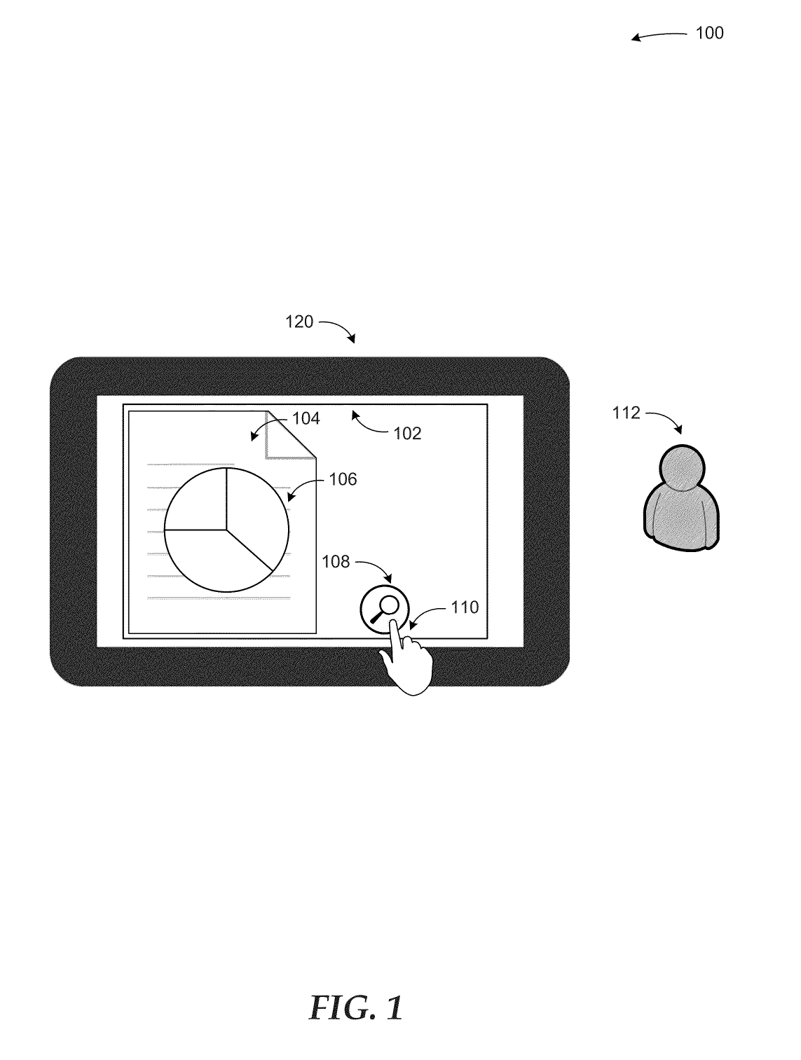

FIG. 1 is a conceptual diagram illustrating components of a scheme to provide an image based search to identify objects in documents, according to embodiments.

In a diagram 100, an application 102 may process an image 106 embedded within a document 104. Alternatively, the image 106 may also be captured from non-digital elements such as a whiteboard, a handwritten document, among others. The image 106 may include a captured picture of a computer generated object such as a chart, a table, a structured text, a shape, among others. The image may also include a scan or a picture of hand-written graphics.

The application 102 may be an imaging application. An example of the imaging application may include a camera application with functionality to capture images using camera hardware associated with a device 120 that executes the application 102. The device 120 may be a mobile device that includes a tablet, a notebook computer, a smart phone, among others.

The application 102 may also be a document application. An example of the document application may include a document processing application, a spreadsheet application, a presentation application, among others. Additionally, the application 102 may utilize a search component to process the image 106. The search component may be executed locally at the device 120. Alternatively, the search component may be executed remotely at a remote computing device with unrestricted computing capacity to overcome a potential computing capacity restriction at the device 120.

The application 102 may present a search control 108 to allow a user 112 to initiate an operation to process the document 104. The document 104 may be processed to identify an object within the image 106 of the document 104. The application 102 may provide a user interface (UI) to allow the user 112 to interact with the application 102 through a number of input modalities. The input modalities that may include a touch based action 110, a keyboard based input, a mouse based input, among others. The touch based action 110 may include a number gestures such as touch action, a swipe action, among others.

The application 102 may execute an operation to process the image 106 to identify an object associated with a portion of the image 106 in response to an activation of the search control 108 by the touch based action 110. Searchable content associated with the object may be detected. The object and the searchable content may be provided for export to the document 104, another application, or another document.

While the example system in FIG. 1 has been described with specific components including the application 102, the image 106, and the object, embodiments are not limited to these components or system configurations and can be implemented with other system configuration employing fewer or additional components.

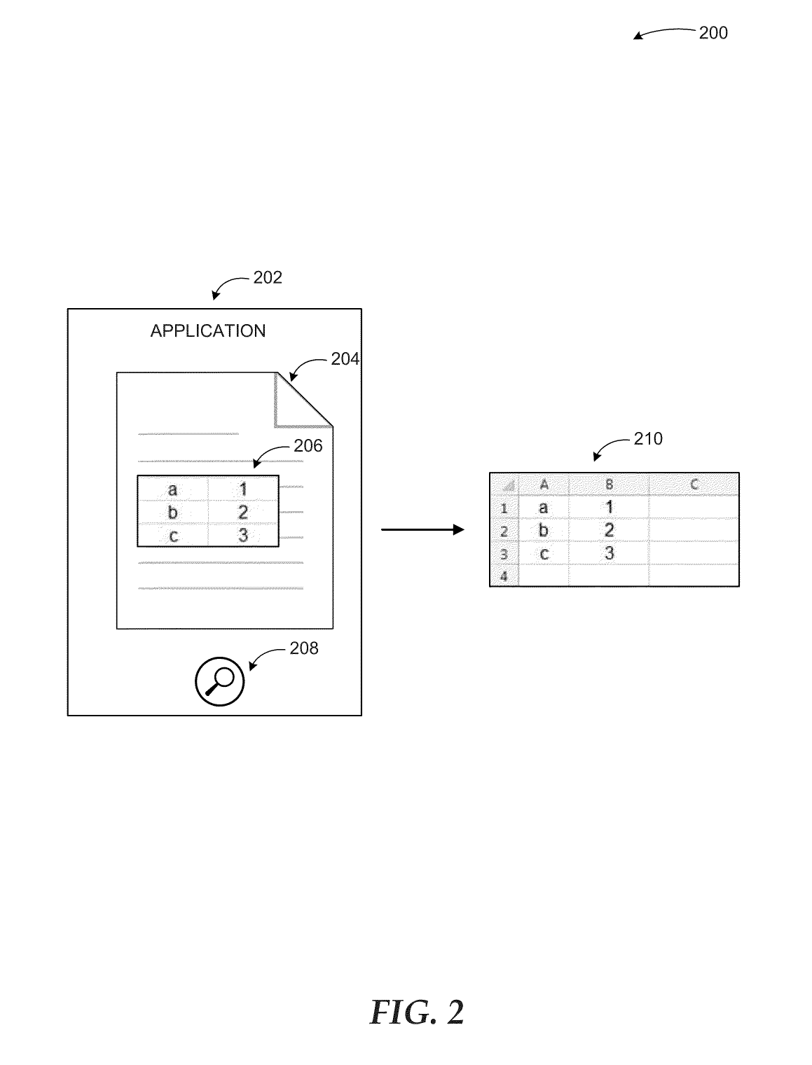

FIG. 2 illustrates an example of processing an image within a document to identify a table as an object and searchable content of the object, according to embodiments.

In a diagram 200, an application 202 may process an image 206 embedded within a document 204 to identify a table 210 as an object within a portion of the image 206. The image 206 may be retrieved from the document 204 by scanning pages of the document 204 to locate the image 206. The image 206 may be identified by a metadata of the document 204 that points to the image 206. Alternatively, the image 206 may be identified by formatting tags such as hypertext markup language (HTML) tags that encapsulate the image 206. The image 206 may also be identified by a data type associated with a container of the image 206. The container of the image 206 may hold pixel based data which may be extrapolated to contain the image 206.

The image 206 may be processed through an image identification module that includes augmented character recognition (OCR) to identify text based data as the table 210 in a structured format from the portion of the image 206. The structured format may include a tabular format or a table format. The tabular format may include formatting of structured text based data with delimiting characters such as a tab character, a space character, a newline character, among others. A table format may include formatting of structured text based data that is partitioned into cells that are placed in rows and columns.

The application 202 may provide a search control 208 that may execute a search operation in response to an activation. The search operation may include processing of the image 206 to identify the table 210, detecting searchable content in the table 210, and providing the object and the searchable content for export. The searchable content may be embedded within the object as metadata. An example may include the application 202 detecting one or more row titles, one or more column titles, a table title, one or more cell values, among others of the table 210 as searchable content. The searchable content may be embedded into the metadata of the table 210 to allow access to text based data that identifies the contents of the table 210.

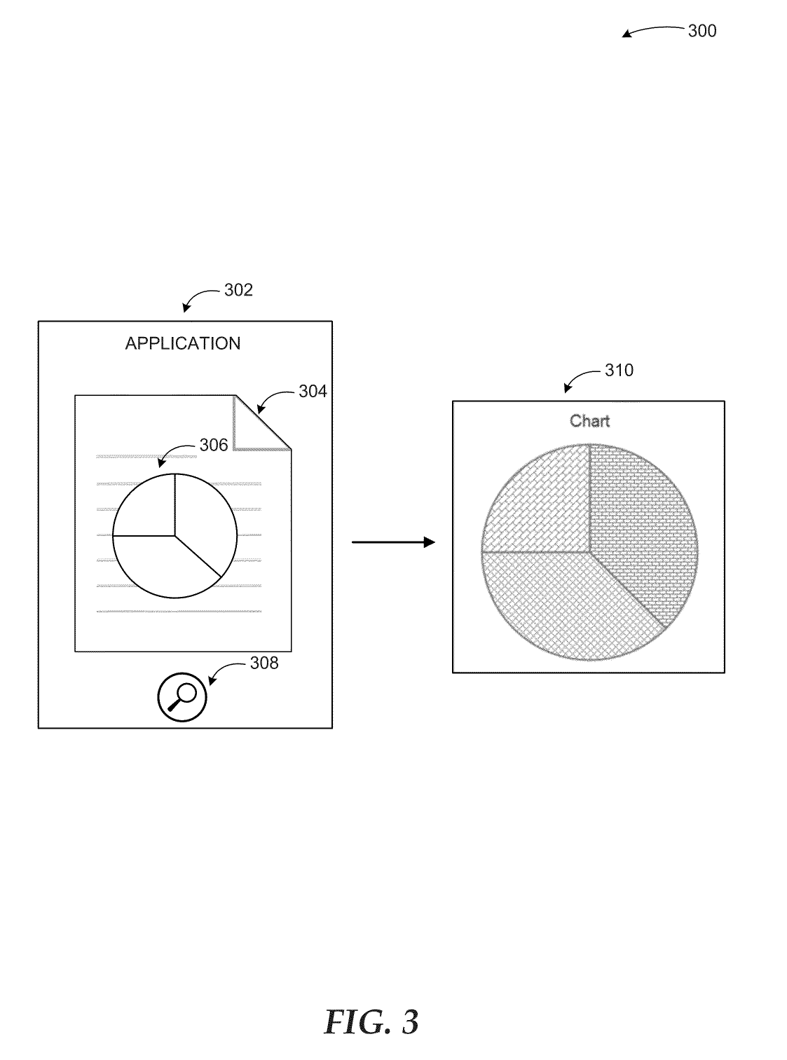

FIG. 3 illustrates an example of processing an image within a document to identify a chart as an object and searchable content of the object, according to embodiments.

In a diagram 300, an application 302 may process an image 306 of a document 304 to identify a chart 310 as an object from a portion of the image 306. The application may initiate a search operation on the document 304 to locate the image 306. The chart 310 and searchable content of the chart 310 may be generated from the portion of the image 306 in response to an activation of a search control 308.

The application 302 may detect a chart title, axis labels, dataset labels, legends, among others as searchable content of the chart 310. The searchable content may be embedded into the chart 310 as metadata to allow access to identify contents of the chart 310 through a search operation of the metadata.

The application 302 may present a prompt to query a type of the chart. The type may include a bar chart, a pie chart, a line chart, an area chart, a scatter chart, among others. The type of the chart may be received as an input. The chart 310 may be generated from the portion of the image 306 based on the type of the chart that acts as a model for the portion. The type of the chart may provide structural information and ranges such as dimensions, fonts, and coloring, among others of elements of the chart 310 that may be used to render the chart 310 from the portion of the image 306. The searchable content associated with the chart 310 may be provided for export to the document 304, another application, or another document.

In an example scenario, the chart 310 may be processed to generate a table of values associated with elements of the chart 310. Data points of the chart 310 may be converted to values to insert into cells of a table. The values may also be provided for a search operation associated with the chart 310 or with the data points of the chart 310. The table may be added into the chart 310. The table may be added into a metadata associated with the chart 310. The values of the table and the text based elements of the chart (such as chart title, axis label, data point values, among others) may be included in the searchable content. Access to identify contents of the chart 310 may be provided through a search operation executed on the searchable content.

In another example scenario, the image 306 may be processed with a set of chart types to match the portion of the image 306 to one of the chart types. The chart 310 may be converted from the portion of the image 306 based on the type of the chart that acts as a model for the portion. Attributes of the chart 310 may be based on settings of the chart type such as placement of elements of the chart that includes labels, data elements, among others.

The application 302 may also detect a document type of the document 304. The document type may include a text based document, a spreadsheet document, a presentation document, among others. The image 306 may be processed with object types associated with the document types. In an example scenario, the image 306 may be processed with object types that include a table object, a chart object, a shape object, among others in response to a detection that matches the document type to a text based document. One of the object types associated with the document type of the document 304 may be detected to match the portion of the image 306. An example may include matching an object type such as a chart object to the portion of the image 306. The portion of the image 306 may be converted to the object based on the matched object type acting as a model for the portion. The model may provide specification information associated with the object for the application 302 to follow while creating the object. The specification information may include boundaries of the object, element sizes, formatting, among others.

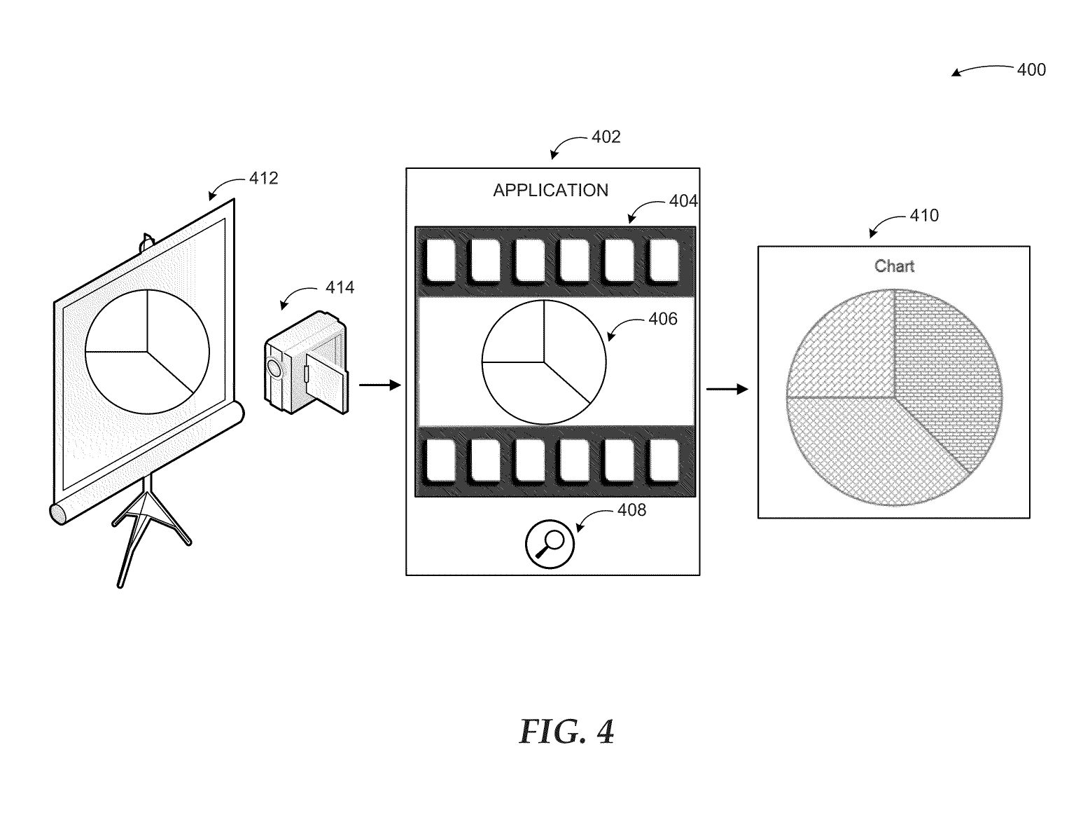

FIG. 4 illustrates an example of processing an image from a video recording to identify an object within the image and searchable content of the object, according to embodiments.

In a diagram 400, an application 402 may process a frame 404 of a video recording to identify an object 410 from a portion of an image 406 within the frame 404. The application 402 may initiate a search operation to process the frame 404 in response to an activation of a search control 408. A capture device 414, such as a video camera, a picture camera, a smartphone, a tablet, among others, may capture the video recording of a screen 412. The screen 412 may display graphics that include computer generated or hand-written graphics. The screen 412 may also display a video of the graphics. The capture device 414 may transmit the video recording, in real-time, as a video stream to the application 402. Alternatively, the capture device 414 may transmit the video recording after completion of the recording session as a video file.

The application 402 may analyze each frame of the video recording to identify the object 410 and searchable content of the object 410. The object 410 may be a chart, a text based data such as a table, among others. Each frame of the video recording may be processed as an image. The searchable content and the object 410 may be provided for export to another application or a document to allow for access to identify contents of the object 410 through a search operation.

Although examples were provided in which an object and searchable content were identified from an image, example scenarios are not limited to an object and searchable content identified from an image. Multiple objects and searchable content of varying types may be identified from an image and exported to multiple documents of varying types.

The technical effect of providing an image based search to identify objects in documents may include enhancements in search and detection of objects in images embedded in containers, such as documents, video files, among others, in view screen limited environments such as mobile devices.

The example scenarios and schemas in FIG. 2 through 4 are shown with specific components, data types, and configurations. Embodiments are not limited to systems according to these example configurations. Providing an image based search to identify objects in documents may be implemented in configurations employing fewer or additional components in applications and user interfaces. Furthermore, the example schema and components shown in FIGS. 2 and 4 and their subcomponents may be implemented in a similar manner with other values using the principles described herein.

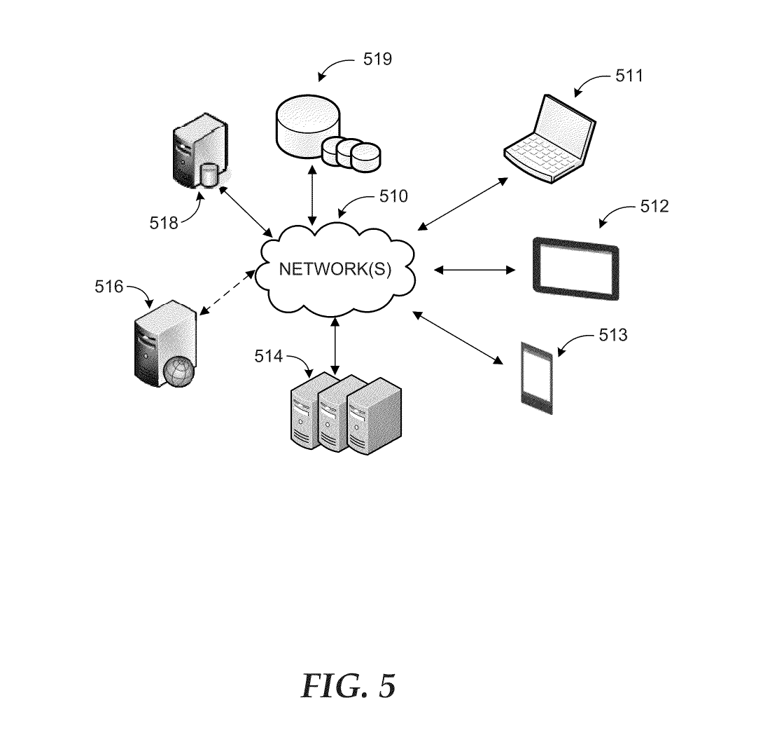

FIG. 5 is an example networked environment, where embodiments may be implemented. A application configured to provide an image based search to identify objects in documents may be implemented via software executed over one or more servers 514 such as a hosted service. The platform may communicate with client applications on individual computing devices such as a smart phone 513, a laptop computer 512, or desktop computer 511 (‘client devices’) through network(s) 510.

Client applications executed on any of the client devices 511-513 may facilitate communications via application(s) executed by servers 514, or on individual server 516. An application may identify an object, such as a chart, a table, among others, from a portion of an image that may be embedded in a document. The portion may be converted to the object and searchable content may be detected in the object. The object and the searchable content may be provided for export to the document, another document, or another application. The application may store data associated with the image in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to provide image based search to identify objects in documents. Furthermore, the networked environments discussed in FIG. 5 are for illustration purposes only. Embodiments are not limited to the example applications, modules, or processes.

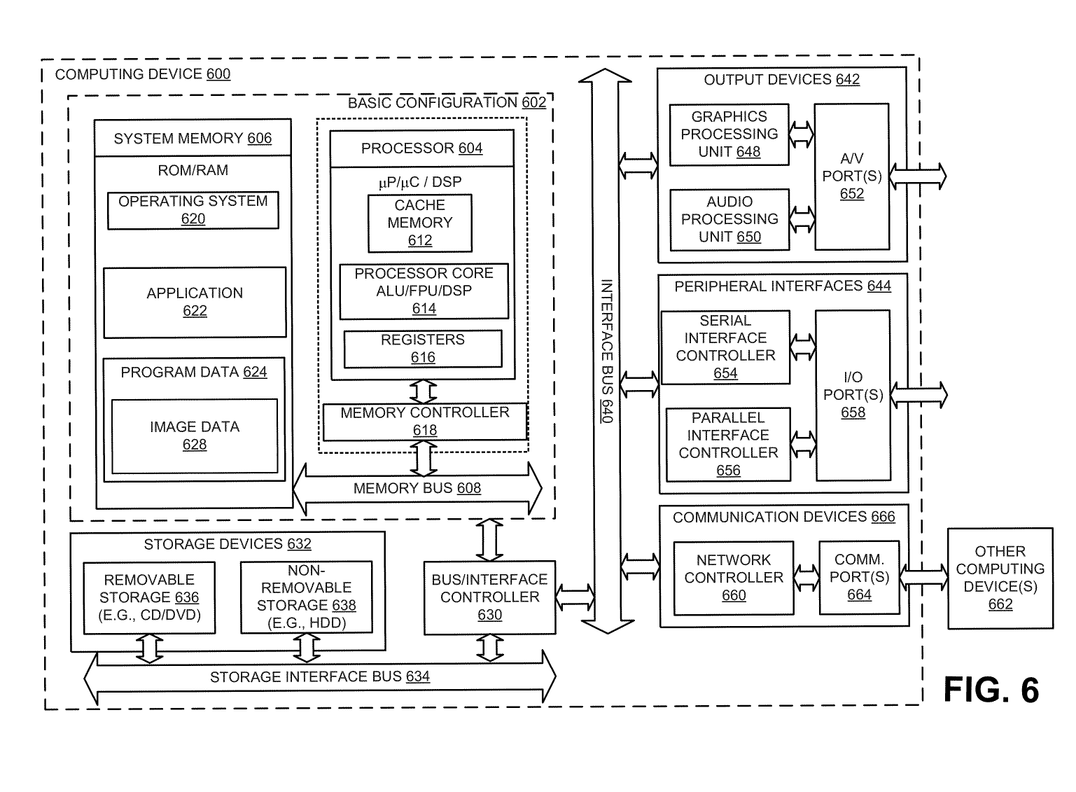

FIG. 6 illustrates a general purpose computing device, which may be configured to provide image based search to identify objects in documents, arranged in accordance with at least some embodiments described herein.

For example, the computing device 600 may be used to provide image based search to identify objects in documents. In an example of a basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including, but not limited to, a microprocessor (μP), a microcontroller (μC), a digital signal processor (DSP), or any combination thereof. The processor 604 may include one more levels of caching, such as a level cache memory 612, a processor core 614, and registers 616. The processor core 614 may include an arithmetic logic unit (ALU), a floating point unit (FPU), a digital signal processing core (DSP Core), or any combination thereof. A memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, an application 622, and a program data 624. The application 622 may provide image based search to identify objects in documents. The program data 624 may include, among other data, an image data 628, or the like, as described herein. The image data 628 may include an object and searchable content associated with the object that may be exported.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636, and the non-removable storage devices 638 may be examples of computer storage media. Computer storage media may include, but may not be limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 may include a graphics processing unit 648 and an audio processing unit 650, which may be configured to communicate to various external devices, such as a display or speakers via one or more A/V ports 652. One or more example peripheral interfaces 644 may include a serial interface controller 654 or a parallel interface controller 656, which may be configured to communicate with external devices, such as input devices (for example, keyboard, mouse, pen, voice input device, touch input device, etc.) or other peripheral devices (for example, printer, scanner, etc.) via one or more I/O ports 658. An example communication device 666 may include a network controller 660, which may be arranged to facilitate communications with one or more other computing devices 662 over a network communication link via one or more communication ports 664. The one or more other computing devices 662 may include servers, client equipment, and comparable devices.

The network communication link may be one example of a communication media. Communication media may be embodied by computer-readable instructions, data structures, program modules, or other data in a modulated data signal, such as a carrier wave or other transport mechanism, and may include any information delivery media. A “modulated data signal” may be a signal that has one or more of the modulated data signal characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer-readable media, as used herein, may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include providing image based search to identify objects in documents. These methods may be implemented in any number of ways, including the structures described herein. One such way may be by machine operations, using devices of the type described in the present disclosure. Another optional way may be for one or more of the individual operations of the methods to be performed in conjunction with one or more human operators performing some of the operations while other operations may be performed by machines. These human operators need not be co-located with each other, but each may be with a machine that performs a portion of the program. In other examples, the human interaction may be automated such as by pre-selected criteria that may be machine automated.

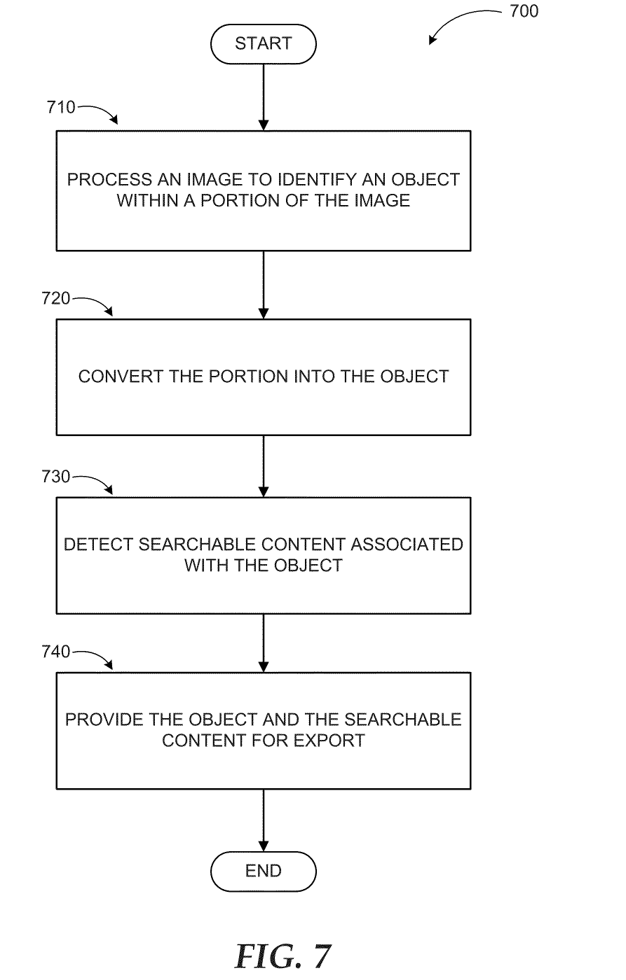

FIG. 7 illustrates a logic flow diagram for a process to provide image based search to identify objects in documents, according to embodiments. Process 700 may be implemented on an application.

Process 700 begins with operation 710, where an image may be processed to identify an object within a portion of the image. The image may be embedded within a document. The portion may be converted into the object at operation 720. At operation 730, searchable content associated with the object may be detected. The object and the searchable content may be provided for export at operation 740. The object may also be searched in one or more data stores using the searchable content to identify entities that encompass the object. The one or more data stores may include a variety of data storage solutions that include local or remote document stores, image stores, among others. The entities may include documents, images, among others.

The operations included in process 700 are for illustration purposes. An application according to embodiments may be implemented by similar processes with fewer or additional steps, as well as in different order of operations using the principles described herein.

According to some examples, a method that is executed on a computing device to provide an image based search to identify objects in documents may be described. The method may include processing an image to identify an object within a portion of the image, converting the portion into the object, detecting searchable content associated with the object, and providing the object and the searchable content for export.

According to other examples, the method may further include retrieving the image from a document. The searchable content may be provided as metadata embedded within the object. The image may be processed through an image identification module that includes augmented optical character recognition (OCR) to identify text based data as the object in a structured format that includes one from a set of: a tabular format and a table format from the portion. A table may be identified as the object. One or more from a set of: one or more row titles, one or more column titles, a table title, one or more cell values of the table may be detected as the searchable content.

According to further examples, the method may further include identifying a chart as the object and detecting at least one from a set of: a chart title, one or more axis labels, one or more dataset labels, and one or more legends as searchable content. A prompt may be presented to query a type of the chart, where the type includes one or more from a set of: a bar chart, a pie chart, a line chart, an area chart, and a scatter chart and an input that includes the type of the chart may be received. The chart may be generated from the portion based on the type of the chart acting as a model for the portion. The chart may be processed to generate a table of values associated with elements of the chart, the table may be added into the chart, and the values and the elements may be included in the searchable content.

According to some examples, a computing device to provide an image based search to identify objects in documents may be described. The computing device may include a memory, a processor coupled to the memory. The processor may be configured to execute an application in conjunction with instructions stored in the memory. The application may be configured to process an image to identify an object within a portion of the image, where the image is retrieved from one from a set of: a document and a video recording, convert the portion into the object, detect searchable content associated with the object, and provide the object and the searchable content for export.

According to other examples, the application is further configured to receive the video recording as one from a set of: a video file and a video stream and analyze a frame of the video recording as the image to detect the object from the frame for each frame of the video recording.

According to further examples, the application is further configured to process the image with a set of chart types to match the portion to one of the chart types, where the chart types include one or more from a set of: a bar chart, a pie chart, a line chart, an area chart, and a scatter chart and convert the portion into a chart as the object based on the chart type acting as a model for the portion.

According to further examples, the application is further configured to detect a document type of the document, where the document type includes one from a set of: a text document, a spreadsheet document, and a presentation document, process the image with object types associated with the document type, detect one of the object types matching the portion of the image, and convert the portion to the object based on the matched object type acting as a model for the portion.

According to some examples, a computer-readable memory device with instructions stored thereon to provide an image based search to identify objects in documents. The instructions may include actions that are similar to the method described above.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device to provide an image based search to identify objects in documents, the method comprising:
processing an image to identify an object within a portion of the image;
converting the portion into the object;
detecting searchable content associated with the object; and
providing the object and the searchable content for export.

2. The method of claim 1, further comprising:
retrieving the image from a document.

3. The method of claim 1, further comprising:
providing the searchable content as metadata embedded within the object.

4. The method of claim 1, further comprising:
processing the image through an image identification module that includes augmented optical character recognition (OCR) to identify text based data as the object in a structured format that includes one from a set of: a tabular format and a table format from the portion.

5. The method of claim 1, further comprising:
identifying a table as the object.

6. The method of claim 5, further comprising:
detecting one or more from a set of: one or more row titles, one or more column titles, a table title, one or more cell values of the table as the searchable content.

7. The method of claim 1, further comprising:
identifying a chart as the object;

8. The method of claim 7, further comprising:
detecting at least one from a set of: a chart title, one or more axis labels, one or more dataset labels, and one or more legends as searchable content.

9. The method of claim 7, further comprising:
presenting a prompt to query a type of the chart, wherein the type includes one or more from a set of: a bar chart, a pie chart, a line chart, an area chart, and a scatter chart; and
receiving an input that includes the type of the chart.

10. The method of claim 9, further comprising:
generating the chart from the portion based on the type of the chart acting as a model for the portion.

11. The method of claim 7, further comprising:
processing the chart to generate a table of values associated with elements of the chart;
adding the table into the chart; and
including the values and the elements in the searchable content.

12. A computing device to provide an image based search to identify objects in documents, the computing device comprising:
a memory;
a processor coupled to the memory and the display, the processor executing an application in conjunction with instructions stored in the memory, wherein the application is configured to:
process an image to identify an object within a portion of the image, wherein the image is retrieved from one from a set of: a document and a video recording;
convert the portion into the object;
detect searchable content associated with the object; and
provide the object and the searchable content for export.

13. The computing device of claim 12, wherein the application is further configured to:
receive the video recording as one from a set of: a video file and a video stream.

14. The computing device of claim 13, wherein the application is further configured to:
analyze a frame of the video recording as the image to detect the object from the frame for each frame of the video recording.

15. The computing device of claim 12, wherein the application is further configured to:
process the image with a set of chart types to match the portion to one of the chart types, wherein the chart types include one or more from a set of: a bar chart, a pie chart, a line chart, an area chart, and a scatter chart; and
convert the portion into a chart as the object based on the chart type acting as a model for the portion.

16. The computing device of claim 12, wherein the application is further configured to:
detect a document type of the document, wherein the document type includes one from a set of: a text document, a spreadsheet document, and a presentation document; and
process the image with object types associated with the document type.

17. The computing device of claim 17, wherein the application is further configured to:
detect one of the object types matching the portion of the image; and
convert the portion to the object based on the matched object type acting as a model for the portion.

18. A computer-readable memory device with instructions stored thereon to provide an image based search to identify objects in documents, the instructions comprising:
processing an image to identify an object within a portion of the image, wherein the image is retrieved from a document;
converting the portion into the object;
detecting searchable content associated with the object; and
providing the object and the searchable content for export.

19. The computer-readable memory device of claim 18, wherein the instructions further comprise:
identifying a chart as the object; and
detecting at least one from a set of: a chart title, one or more axis labels, one or more dataset labels, and one or more legends as searchable content.

20. The computer-readable memory device of claim 18, wherein the instructions further comprise:
identifying a table as the object; and
detecting at least one from a set of: one or more row titles, one or more column titles, a table title, one or more cell values of the table as the searchable content.
